(19) United States
(12) Patent Application Publication
(10) Pub. No.: US 2008/0238803 A1
(43) Pub. Date: Oct. 2, 2008

(54) EXTREMELY MINIATURIZED FM FREQUENCY BAND ANTENNA

(76) Inventors: Tsai-Yi Yang, Kuntien Hsiang (TW); Te-Yi Chu, Kuntien Hsiang (TW)

Correspondence Address: HDSL, 4331 STEVENS BATTLE LANE, FAIRFAX, VA, 22033, US

(21) Appl. No.: 11/693,887

(22) Filed: Mar. 30, 2007

(51) Int. Cl. H01Q 1/48

(52) U.S. Cl. 343/848

(57) ABSTRACT

An extremely miniaturized FM frequency band antenna built in a mobile device includes a substrate and an antenna unit. The substrate is provided with a plate having a grounding metallic surface and a first clearance surface. A second clearance surface provided on the same side of the grounding metallic surface has a metallic micro strip line. One end of the metallic micro strip line extends to a bottom end of the second clearance surface and has a first contact. The other end of the micro strip line extends onto the first clearance surface and has a second contact. Further, a third contact is provided on the first clearance surface at a position corresponding to that of the second contact. Finally, the antenna unit is electrically connected on the second and third contacts to form a FM antenna for receiving FM signals.

### BACKGROUND OF THE INVENTION

1. Field of the Invention

The present invention relates to a frequency modulation (FM) antenna, and in particular to a FM antenna that can be built in a mobile reception device.

2. Description of Prior Art

It is well known that MP3 music files can be stored in a memory of a current mobile device, such as MP3, iPod, recording pen or other players. Therefore, after the music files are decompressed and played in the player, a user can put on an earphone to listen to the MP3 music files downloaded in the memory anytime and anywhere

In addition to allow the user to listen to the MP3 music, such players are provided with a built-in FM reception module whereby FM broadcast programs can be also received. After the user switches the player to the FM reception module or presses the button of the FM reception module, the user can listen to the FM broadcast programs.

As shown in FIG. 1, after the user switches a conventional player 1A to the FM reception module or presses the button 12A of the FM reception module, a plug 21A of a earphone 2A should be inserted into an earphone hole 11A, thereby allowing the user to listen to the FM broadcast programs. Since the player 1A is not provided with a built-in antenna for receiving FM signals, an earphone line 22A is used as an antenna for receiving FM signals, thereby allowing the user to listen to the FM broadcast programs. If the user intends to play the music by means of a speaker on the player 1A, an external antenna 3A should be further connected thereto. After a plug 31A of the antenna 3A is inserted into the earphone hole 11A, the audio signals of the FM broadcast programs listened by the user can be played via an output hole 13A of the speaker. However, if the earphone or the external antenna is lost, the user cannot listen to the FM broadcast programs, and thus he needs to buy a new ear and the antenna. Therefore, this is a serious problem in the external FM antenna of the conventional player 1A.

### SUMMARY OF THE INVENTION

Therefore, the object of the present invention is to provide an extremely miniaturized FM frequency band antenna that can be built in a mobile device. When the mobile device has such a built-in FM reception module, FM broadcast programs can be received without providing an external FM frequency band antenna

In order to achieve the above objects, the present invention provides a FM frequency band antenna structure comprising a substrate and an antenna unit.

The substrate is provided with a plate having a grounding metallic surface and a first clearance surface. On the same side of the grounding metallic surface, a second clearance surface is provided for allowing the substrate to be exposed to the outside. The second clearance surface has a metallic micro strip line thereon. One end of the metallic micro strip line extends to a bottom end of the second clearance surface and has a first contact. The first contact is electrically connected with a lead or a coaxial lead column, thereby forming a signal input point. The other end of the micro strip line extends onto the first clearance surface outside the second clearance surface and has a second contact. Further, a third contact is provided on the first clearance surface at a position corresponding to that of the second contact.

The antenna unit has an elongated cubic carrier. Both ends of the carrier are covered with a first electrode and a second electrode, respectively. A lead is electrically connected between the first and second electrodes for covering on the surface of the carrier.

### BRIEF DESCRIPTION OF THE DRAWINGS

FIG. 1 is a schematic view showing the external appearance of a conventional mobile device;

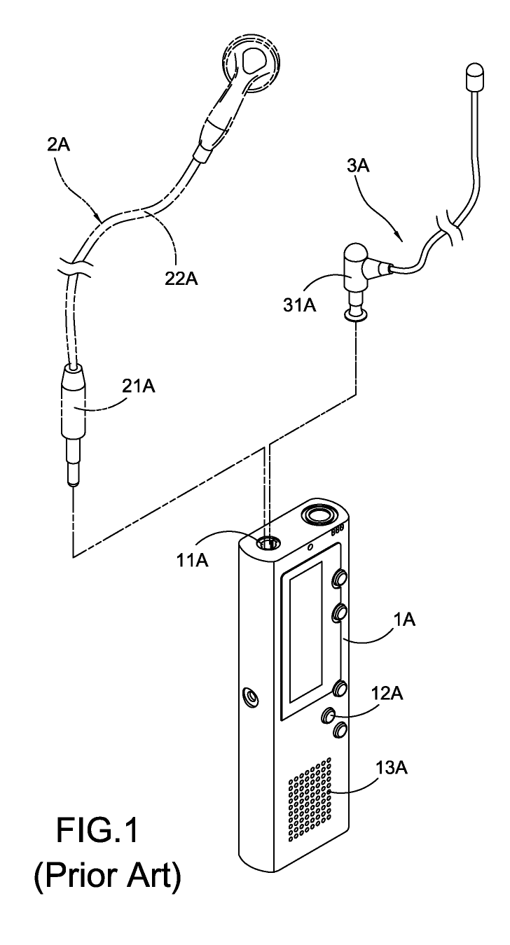

FIG. 2 is a perspective view showing the external appearance of the FM frequency band antenna structure of the present invention;

FIG. 3 is an exploded view showing the FM frequency band antenna structure of the present invention;

FIG. 4 is a schematic view showing a first embodiment of the present invention;

FIG. 5 is a schematic view showing a second embodiment of the present invention;

FIG. 6 is a schematic view showing a third embodiment of the present invention; and

FIG. 7 is a schematic view showing a fourth embodiment of the present invention.

### DETAILED DESCRIPTION OF THE INVENTION

The technical contents and the detailed explanation of the present invention are described with reference to the accompanying drawings.

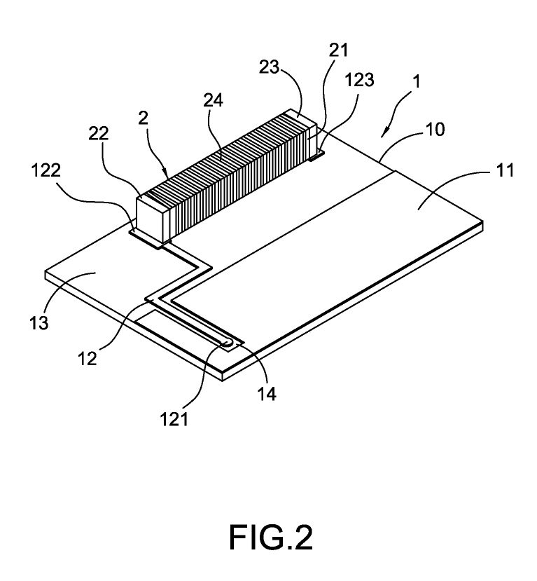

With reference to FIG. 2, it is a perspective view showing the external appearance of the FM frequency band antenna structure of the present invention. As shown in this figure, the FM frequency band antenna of the present invention has a substrate 1 and an antenna unit 2 electrically connected onto the substrate 1. The substrate 1 is formed with a grounding metallic surface 11 thereon. On the grounding metallic surface 11, the clearance substrate 1 is formed with a step-like metallic micro strip line 12 thereon. The metallic micro strip line 12 acts as an input end for receiving signals. One end of the micro strip line 12 is electrically connected with one end of the antenna unit 2. With the above components, an extremely miniaturized FM frequency band antenna can be obtained and built in a portable mobile device. Such a built-in FM reception module is used to receive signals from a FM station, thereby allowing a user to listen to broadcast programs.

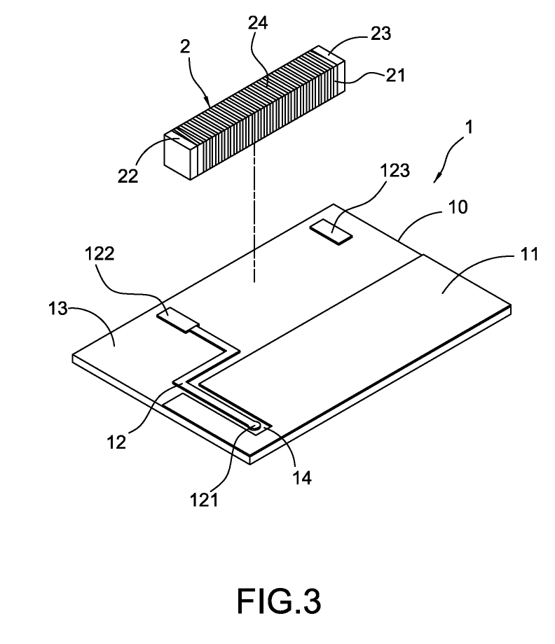

With reference to FIG. 3, it is an exploded view showing the FM frequency band antenna structure of the present invention. As shown in this figure, the FM frequency band antenna structure includes a substrate 1 and an antenna unit 2.

The substrate 1 is provided with a plate 10 that is formed thereon with a grounding metallic surface 11 and a first clearance surface 13. On the same side of the grounding metallic surface 11, an U-shaped second clearance surface 14 is provided for allowing the surface of the substrate 1 to be exposed. The second clearance surface 14 is formed thereon with a metallic micro strip line 12. One end of the metallic micro strip line 12 extends to a bottom end of the second clearance surface 14 and has a first contact 121. The first contact 121 is electrically connected with a lead or a coaxial lead column, thereby forming a signal input point. Via this arrangement, signals can be transmitted to a circuit board of a mobile device (not shown). The other end of the micro strip line 12 extends onto the first clearance surface 13 of the substrate outside the second clearance surface 14, thereby forming a second contact 122. Further, a third contact 123 is provided on the first clearance surface 13 of the substrate 1 at a position corresponding to that of the second contact 122.

The antenna unit 2 is made into an elongated cubic carrier 21 by ceramic materials having a high dielectric constant (>80). Both ends of the carrier 21 are covered with a first electrode 22 and a second electrode 23, respectively. A helical lead 24 is electrically connected between the first electrode 22 and the second electrode 23 for covering the surface of the carrier 21.

When the substrate 1 and the antenna unit 2 of the FM frequency band antenna structure are completely made, the first and second electrodes 22, 23 of the antenna unit 2 are electrically connected to the second and third contacts 122, 123, respectively. When receiving the FM broadcast programs, the antenna unit 2 transmits the received signals to the first contact 121 via the metallic micro strip line 12. Then, the signals are input to a main circuit board of the mobile device via the first contact 121, which will be described later. The user only needs to turn on the power supply of the mobile device (such as a mobile phone, mp3, recording pen or the like) and switches to a FM reception function or presses the FM button directly, thereby receiving the FM broadcast programs. Therefore, the above arrangement can solve the problem existed in the conventional mobile device that the user needs to insert an earphone or antenna into an earphone hole to listen to the FM broadcast programs.

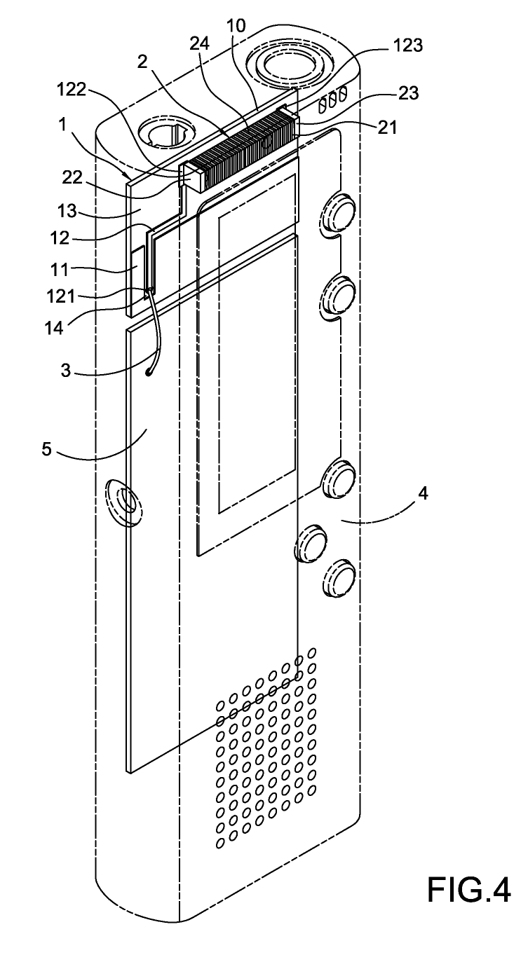

With reference to FIG. 4, it is a schematic view showing a first embodiment of the present invention. As shown in this figure, when the FM antenna structure is completely manufactured, the first contact 121 of the micro strip line 12 is electrically connected to a lead 3, and the other end of the lead 3 is electrically connected to a main circuit board 5 of the mobile device. The user only needs to turn on the power supply of the mobile device (such as a mobile phone, mp3, recording pen or the like) and switches to the FM reception function or presses the FM button directly, thereby receiving the FM broadcast programs.

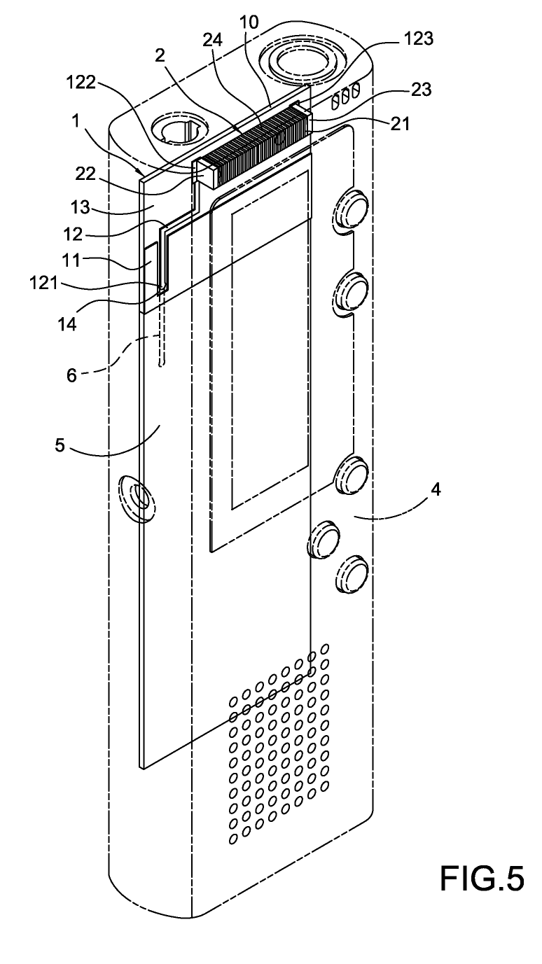

With reference to FIG. 5, it is a schematic view showing a second embodiment of the present invention. As shown in this figure, the substrate 1 of the FM antenna structure of the present invention and the main circuit board 5 of the mobile device 4 can be the same circuit board. During the manufacturing of the main circuit board 5 of the mobile device 3, the grounding metallic surface 11 of the substrate 1, the first contact 121, the second contact 122 and the third contact 123 of the micro strip line 12 can be directly made on the main circuit board 5. The antenna unit 2 is electrically connected to the second and third contacts 122, 123 of the main circuit board 5 directly. The back or front surface of the main circuit board 5 is formed with a metallic lead 6 for electrically connecting with the first contact 121. After the antenna unit 2 receives the signals, the metallic lead 6 transmits the signals to the circuitry of the main circuit board 5 via the micro strip line 12 and the first contact 121, thereby receiving the FM broadcast programs.

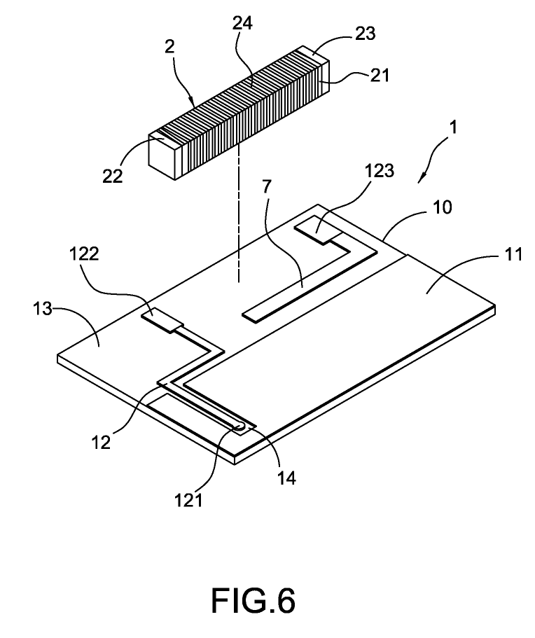

With reference to FIG. 6, it is a schematic view showing a third embodiment of the present invention. As shown in this figure, in the FM antenna structure of the present invention, a metallic line 7 extends from the distal end of the third contact 123 of the substrate 1 according to the environmental conditions, thereby increasing the radiation gain. Furthermore, the width or length of the metallic line 7 can be adjusted to obtain an optimal central resonant frequency of the antenna via fine adjustment.

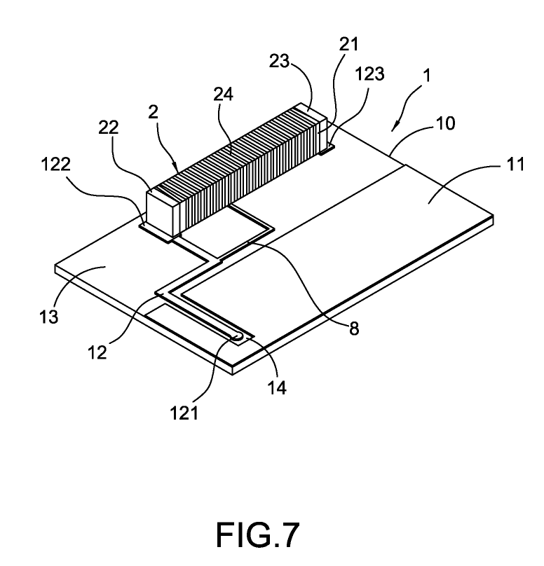

With reference to FIG. 7, it is a schematic view showing a fourth embodiment of the present invention. As shown in this figure, the antenna unit 2 is made into a carrier 21 by block-like materials having a high dielectric constant. The conductive metallic lead 24 wraps to cover on the surface of the carrier, thereby substantially reducing the dimension of the antenna unit 2. The lead 24 is further electrically connected with the metallic lead 8 (copper foil) on the substrate 1, so that the lead 24 (coil) between the connecting portion of the metallic lead 8 and the lead 24 and the first electrode 22 generates a short circuit, thereby adjusting the resonant frequency of the antenna built in the device to an optimal FM frequency band.

What is claimed is:

1. An extremely miniaturized FM frequency band antenna structure built in a mobile device for receiving FM signals, comprising:
a substrate provided with a plate having a grounding metallic surface and a first clearance surface, a second clearance surface being provided on the same side of the grounding metallic surface for allowing the surface of the substrate to be exposed, the second clearance surface having a metallic micro strip line, one end of the metallic micro strip line extending to a bottom end of the second clearance surface to form a first contact, the other end of the micro strip line extending onto the first clearance surface outside the second clearance surface to form a second contact, a third contact being provided on the first clearance surface at the position corresponding to that of the second contact; and an antenna unit electrically connected on the second and third contacts.

2. The extremely miniaturized FM frequency band antenna structure according to claim 1, wherein the first contact is electrically connected with a lead or a coaxial lead column to form a signal input point.

3. The extremely miniaturized FM frequency band antenna structure according to claim 1, wherein the metallic micro strip line is step-like.

4. The extremely miniaturized FM frequency band antenna structure according to claim 1, wherein the second clearance surface is U-shaped.

5. The extremely miniaturized FM frequency band antenna structure according to claim 1, wherein the antenna unit is made into an elongated cubic carrier by ceramic materials having a dielectric constant larger than 80.

6. The extremely miniaturized FM frequency band antenna structure according to claim 5, wherein both ends of the carrier are covered respectively with a first electrode and a second electrode, and a lead is electrically connected between the first and second electrodes for covering the surface of the carrier.

7. The extremely miniaturized FM frequency band antenna structure according to claim 6, wherein the lead is helical.

8. The extremely miniaturized FM frequency band antenna structure according to claim 1, wherein the substrate and the main circuit board of the mobile device are the same circuit board.

9. The extremely miniaturized FM frequency band antenna structure according to claim 1, wherein a metallic line extends from the distal end of the third contact to increase the radiation gain.

10. The extremely miniaturized FM frequency band antenna structure according to claim 1, wherein the width or length of the metallic line is adjusted to thus adjust the radiation gain.

11. The extremely miniaturized FM frequency band antenna structure according to claim 1, wherein the lead is electrically connected with the metallic lead (copper foil) on the substrate, so that the lead (coil) between the connecting portion of the metallic lead and the lead and the first electrode generates a short circuit, thereby adjusting the resonant frequency of the antenna built in the device to an optimal FM frequency band
